(19) United States
(12) Patent Application Publication
(10) Pub. No.: US 2017/0071351 A1
(43) Pub. Date: Mar. 16, 2017

(54) BACK SUPPORT DEVICES WITH FORCE DISTRIBUTING KNEE PADS

(71) Applicant: Katherine L. Krug, Las Vegas, NV (US)

(72) Inventor: Katherine L. Krug, Las Vegas, NV (US)

(21) Appl. No.: 15/265,812

(22) Filed: Sep. 14, 2016

Related U.S. Application Data
(60) Provisional application No. 62/219,025, filed on Sep. 15, 2015.

(51) Int. Cl. A47C 16/00; F16M 13/04

(52) U.S. Cl. CPC A47C 16/005; F16M 13/04

(57) ABSTRACT

A back support apparatus for applying a support force to a user's back by using the user's knees while in a seated position including a back support member having a first end and an opposing second end, a pair of adjustable strap members coupled to and extending from the first and second ends of the back support member, and a pair of force distributing knee pads slidably coupled to the pair of adjustable strap members, the force distributing knee pads configured to receive the user's knees and to distribute a force applied by the pair of adjustable strap members along both horizontal and vertical planes, wherein a first adjustable strap member and a first force distributing knee pad is placed around the user's first knee, and a second adjustable strap member and a second force distributing knee pad is placed around the user's second knee, and wherein the support force applied by the back support member onto the user's back is generated by adjusting a length of the first and second adjustable strap members.

### BACKGROUND OF THE INVENTION

1. Field of the Invention

The present general inventive concept relates to back support devices, and more particularly, to back support devices configured to support a user in a proper posture while in a seated position by using the user's knees. The back support devices according to the present general inventive concept include force distributing knee pads which are designed to distribute a force applied to the user's knees to reduce an amount of fatigue experienced by the user. The back support devices according to the present general inventive concept further include inflatable back support members and/or inflatable force distributing knee pads which are designed to receive and store air in order to adjustably apply a force to the user's back and/or knees.

2. Description of the Related Art

A person's posture refers to his or her body alignment and position with respect to gravity while standing, sitting, or lying down. Proper posture decreases an amount of stress on ligaments holding the person's joints and spine together and reduces fatigue since muscles are being used more efficiently, and therefore allows the person's body to use less energy. According to several medical professionals, the proper healthy posture for sitting in a chair requires one to sit up with his or her back straight and shoulders back. The person's knees should be maintained at a right angle and even with or slightly higher than his or her hips. In addition, the person's feet should be kept flat on the floor to distribute the user's body weight evenly on both hips. However, many people are unable to achieve and maintain in this posture for extended lengths of time and therefore often experience neck and back pain and excessive fatigue. As a result, several types of back support devices have been developed which support a user in a proper posture, by using the user's knees. However, these support devices typically concentrate forces along a single plane of the user's knees which often results in excessive fatigue and discomfort to the user.

As such, there remains a need for back support devices which help support users in a proper posture, while distributing forces applied to the user's knees in multiple planes in order to help reduce user fatigue.

### BRIEF SUMMARY OF THE INVENTION

The present general inventive concept provides back support devices configured to support a user in a proper posture while in a seated position by using the user's knees. The present general inventive concept also provides back support devices which have force distributing knee pads that are designed to distribute a force applied to the user's knees to reduce an amount of fatigue experienced by the user. The present general inventive concept also provide back support devices according to the present general inventive concept further include inflatable back support members and/or inflatable force distributing knee pads which are designed to receive and store air in order to adjustably apply a force to the user's back and/or knees.

The foregoing and/or other aspects of the present general inventive concept may be achieved by providing a back support apparatus for applying a support force to a user's back by using the user's knees while in a seated position including a back support member having a first end and an opposing second end, a pair of adjustable strap members coupled to and extending from the first and second ends of the back support member, a pair of force distributing knee pads slidably coupled to the pair of adjustable strap members, the force distributing knee pads configured to receive the user's knees and to distribute a force applied by the pair of adjustable strap members along both horizontal and vertical planes, wherein a first adjustable strap member and a first force distributing knee pad is placed around the user's first knee, and a second adjustable strap member and a second force distributing knee pad is placed around the user's second knee, and wherein the support force applied by the back support member onto the user's back is generated by adjusting a length of the first and second adjustable strap members.

The first adjustable strap member may include a first end and an opposing second end coupled to the first end of the back support member, and the second adjustable strap member may include a first end and an opposing second end coupled to the second end of the back support member.

The pair of force distributing knee pads may include a knee contact region to contact the user's knee.

The pair of force distributing knee pads may be formed in a wedge shape to evenly distribute a force over a surface of the user's knees.

The knee contact region may include a padding material to protect the user's knee.

The pair of force distributing knee pads may each include a strap attachment member positioned at an angle with respect to the knee contact region.

The angle may be between 5 degrees to 45 degrees. However, the present inventive concept is not limited thereto.

The support force applied to the user's back at the back support member may be generated by the user's first and second knees through the first and second adjustable strap members to thereby support the user in a proper posture position.

An amount of the support force distributed along the horizontal plane may be based on the angle between the strap attachment member and the knee contact region.

An amount of the support force distributed along the vertical plane may be based on the angle between the strap attachment member and the knee contact region.

The back support apparatus may further include a fastening member coupled to a perimeter of the back support member to open and close a storage compartment formed by the back support member.

The fastening member may includes one of a snap, a button, a zipper, a hook and loop fastener, and a clip.

The back support apparatus may further include a clip member configured to detachably connect the first adjustable strap member to the second adjustable strap member to prevent the user's knees from spreading apart.

The foregoing and/or other aspects of the present general inventive concept may be achieved by also providing a back support apparatus for applying an adjustable support force onto a user's back by using the user's knees while in a seated position which includes a back support member having a first end and an opposing second end and an inflatable back portion, pair of adjustable strap members coupled to and extending from the first and second ends of the back support member, and a pair of force distributing knee pads slidably coupled to the pair of adjustable strap members, the force distributing knee pads having an inflatable knee portion configured to receive the user's knees and to adjustably distribute a force applied by the pair of adjustable strap members along both horizontal and vertical planes, wherein a first adjustable strap member and a first force distributing knee pad is placed around the user's first knee, and a second adjustable strap member and a second force distributing knee pad is placed around the user's second knee.

An amount of support force applied by the back support member onto the user's back may be controlled by adjusting a length of the first and second adjustable strap members.

An amount of support force applied by the back support member onto the user's back is controlled based on an amount of air disposed within the inflatable back portion and/or the inflatable knee portion.

The inflatable back portion and knee portion may each include an air valve which is used to adjust an amount of air disposed with the inflatable portion.

The inflatable back portion may be detachably coupled to the back support member.

The inflatable back portion may be integrally formed with the back support member.

Additional aspects of the present general inventive concept will be set forth in part in the description which follows and, in part, will be obvious from the description, or may be learned by practice of the general inventive concept.

### BRIEF DESCRIPTION OF THE FIGURES

These and/or other aspects of the present general inventive concept will become apparent and more readily appreciated from the following description of the various embodiments, taken in conjunction with the accompanying drawings of which:

FIG. 1 illustrates a front perspective view of a back support device and force distributing knee pads according to an example embodiment of the present general inventive concept;

FIG. 2 illustrates a back perspective view of the back support device and force distributing knee pads illustrated in FIG. 1;

FIG. 3A illustrates a side plan view of a force distributing knee pad according to an exemplary embodiment of the present general inventive concept;

FIG. 3B is a partial side plan view of the force distributing knee pad illustrated in FIG. 3A assembled to an adjustable strap member;

FIG. 4 illustrates a side view of the back support device illustrated in FIG. 1;

FIG. 5A illustrates a side perspective view of the force distributing knee pad illustrated in FIG. 1;

FIG. 5B illustrates a top plan view of the force distributing knee pad illustrated in FIG. 5A;

FIG. 5C illustrates a back view of the force distributing knee pad illustrated in FIG. 5B;

FIG. 5D illustrates a side view of the force distributing knee pad illustrated in FIG. 5A;

FIG. 5E illustrates a partial cross-sectional view of the force distributing knee pad along line A-A illustrated in FIG. 5C;

FIG. 6 illustrates a side perspective view of a back support device attached to a user's back and knees;

FIG. 7 illustrates a side view of the back support device and force distributing knee pads illustrated in FIG. 6;

FIG. 8 illustrates a front perspective view of a back support device and force distributing knee pads according to another example embodiment of the present general inventive concept;

FIG. 9 illustrates a front perspective view of a back support device and force distributing knee pads according to another example embodiment of the present general inventive concept;

FIG. 10 illustrates a front perspective view of a back support device and force distributing knee pads according to another example embodiment of the present general inventive concept;

FIG. 11 illustrates a front perspective exploded view of a back support device and force distributing knee pads according to another example embodiment of the present general inventive concept; and

FIG. 12 illustrates a front perspective exploded view of a back support device and force distributing knee pads according to another example embodiment of the present general inventive concept.

### DETAILED DESCRIPTION OF THE PREFERRED EMBODIMENTS

Reference will now be made to the example embodiments of the present general inventive concept, examples of which are illustrated in the accompanying drawings and illustrations. The example embodiments are described herein in order to explain the present general inventive concept by referring to the figures.

The present general inventive concept relates to back support devices, and more particularly, to back support devices configured to support a user in a proper posture, while in a seated position, by using the user's limbs, such as knees. The back support devices according to the present general inventive concept include force distributing knee pads which are designed to distribute a force applied to the user's knees and/or back, along multiple planes. In addition, the force distributing knee pads are specifically designed in a wedge shape and configured to distribute a force applied to the user's knees over a wide surface area of knee. Further, the knee pads are designed to include a strap attachment member which is inclined (i.e., angled) with respect to a surface that contacts the user's knee in order to distribute a force in a horizontal plane (i.e., a first plane P1) and in a vertical plane (i.e., a second plane P2), thereby reducing an amount of force applied directly along a single plane of the user's knee. The amounts of force distributed in the horizontal plane P1 (i.e., horizontal force) and in the vertical plane (i.e., vertical force) are based on the angle between a surface of the strap attachment portion and the surface of the knee pad which contacts the user's knee.

In alternative embodiments, the back support devices according to the present general inventive concept may also be used to improve a user's ergonomics, while in various positions including sitting. The back support devices may be used to stabilize or position a user's pelvis to thereby restore the user's spines natural curvature and provide lumbar support. However, the present general inventive concept is not limited thereto.

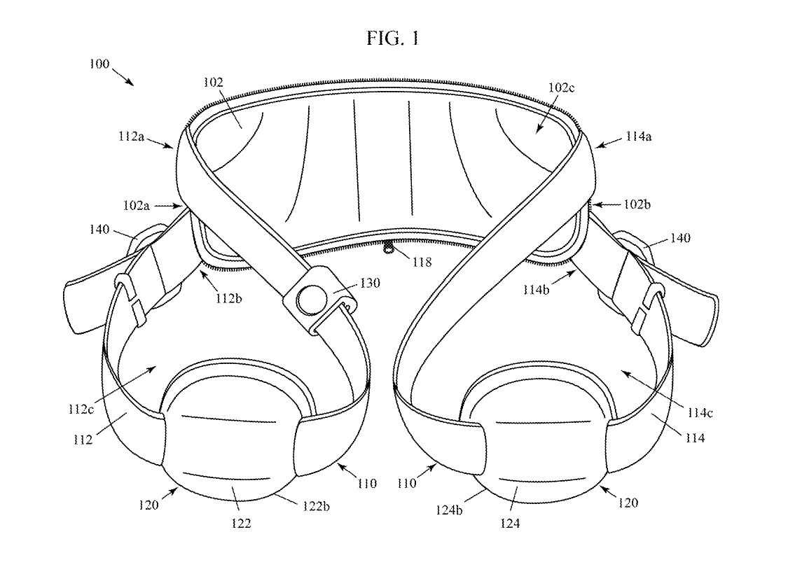

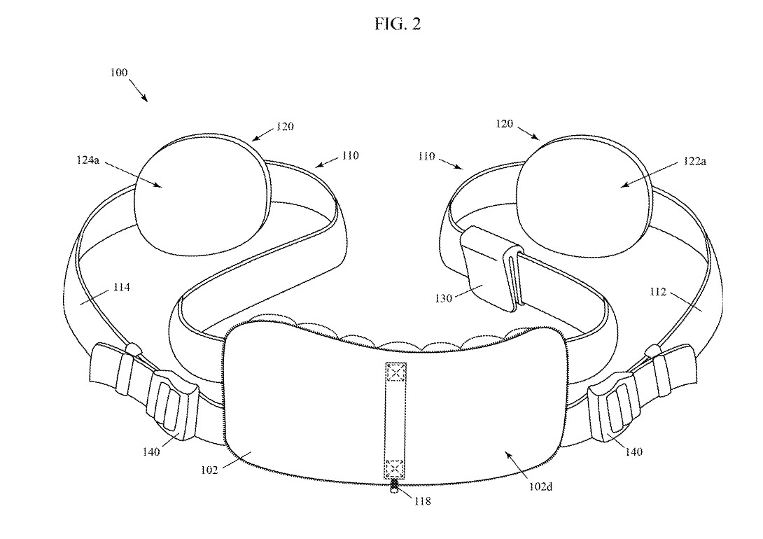

FIG. 1 illustrates a top perspective view of a back support device 100 and force distributing knee pads 120 according to an example embodiment of the present general inventive concept. FIG. 2 illustrates a back perspective view of the back support device 100 and force distributing knee pads 120 illustrated in FIG. 1.

Referring to FIGS. 1 and 2, in the present embodiment, the back support device 100 includes a back support member 102 having a first end 102a (i.e., a proximal end), an opposing second end 102b (i.e., a distal end), a first surface 102c (i.e., a front surface), and an opposing second surface 102d (i.e., a back surface). The back support device 100 further includes a pair of adjustable strap members 110 attached to the first and second ends 102a and 102b of the back support member 102, and a pair of force distributing knee pads 120 slidably coupled to the adjustable strap members 110. The pair of adjustable strap members 110 includes a first adjustable strap member 112 coupled to first end 102a of the back support member 102 and a second adjustable strap member 114 coupled to the second end 102b of the back support member 102.

In the present embodiment, the first adjustable strap member 112 includes a first end 112a and an opposing second end 112b which are coupled to the first end 102a of the back support member 102, and the second adjustable strap member 114 includes a first end 114a and an opposing second end 114b which are coupled to the second end 102b of the back support member 102. As such, the first adjustable strap member 112 forms a first loop 112c which is wrapped around a user's first knee and the second adjustable strap member 114 forms a second loop 114c which is wrapped around the user's second knee.

In the present embodiment, the pair of force distributing knee pads 120 includes a first force distributing knee pad 122 slidably coupled to the first loop 112c formed by the first adjustable strap member 112, and a second force distributing knee pad 124 slidably coupled to the second loop 114c formed by the second adjustable strap member 114. The first and second force distributing knee pads 122, 124 are designed and/or configured to receive the user's knees and to distribute a force from the pair of adjustable strap members 112, 114 along both horizontal and vertical planes P1, P2 of the user's knees.

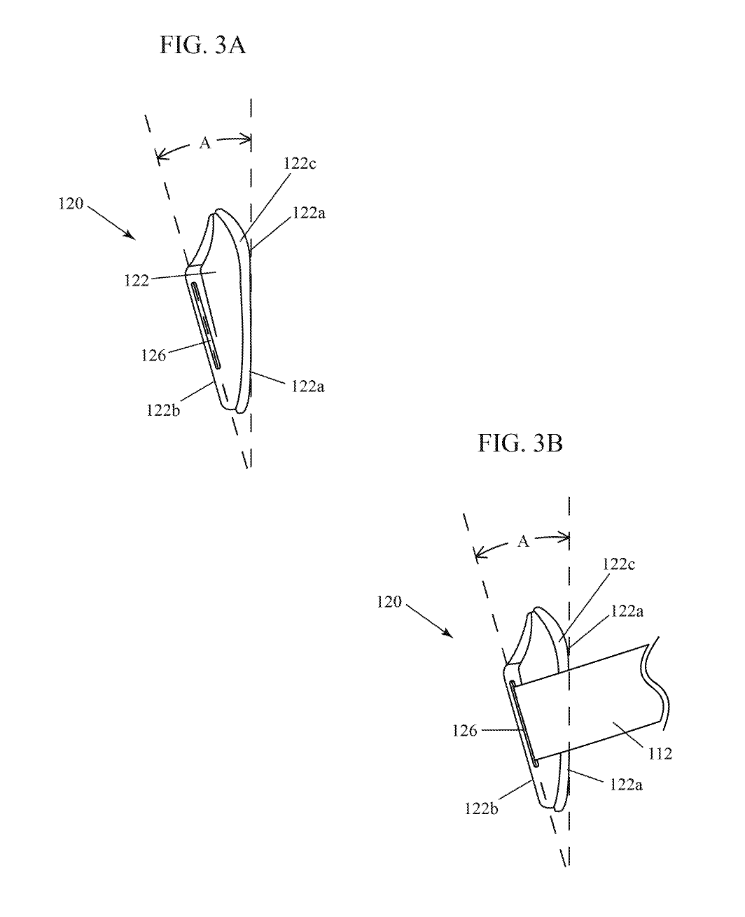

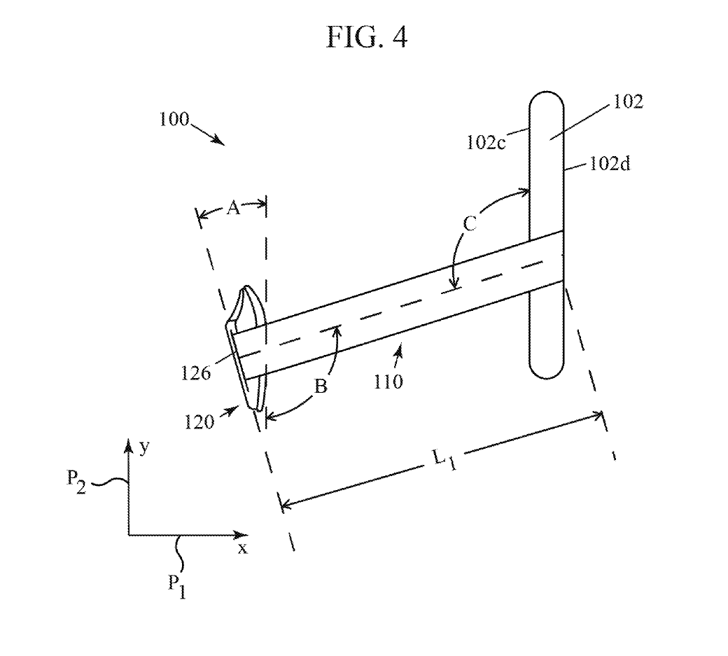

FIG. 3A illustrates a side plan view of a force distributing knee pad 120 according to an exemplary embodiment of the present general inventive concept and FIG. 3B is a partial side plan view of the force distributing knee pad 120 illustrated in FIG. 3A assembled to an adjustable strap member 110. FIG. 4 illustrates a side view of the back support device 100 illustrated in FIG. 1.

Referring to FIG. 3A, the pair of force distributing knee pads 122, 124 further includes a knee contact region 122a, 124a to contact, protect, and/or comfort the user's knee and an outer rigid shell 122b, 124b to help maintain a shape of the knee pad 122, 124. The knee contact region 122a, 124a may further include a padding material 122c to help protect the user's knee. However, the present general inventive concept is not limited thereto.

In the present embodiment, the back support device 100 further includes a clip member 130 which is designed and/or configured to detachably connect the first adjustable strap member 112 to the second adjustable strap member 114 in order to prevent the user's knees from spreading apart.

In alternative exemplary embodiments, the back support device 100 may further include a fastening member 118 which is coupled to a perimeter of the back support member 102 and used to open and close a storage compartment (not illustrated) formed by the back support member 102. That is, the back support member 102 may be folded over itself in order to create the storage compartment which may be used to store the pair of adjustable strap members 112, 114 and the pair of force distributing knee pads 122, 124, when not in use.

In alternative embodiments, the fastening member 118 includes one of a snap, a button, a zipper, a hook and loop fastener, a clip, or the like to secure the pair of adjustable strap members 112, 114 and the pair of force distributing knee pads 122, 124 within the storage compartment formed by the folded back support member 102. However, the present general inventive concept is not limited thereto.

In alternative example embodiments, the pair of force distributing knee pads 122, 124 may be constructed solely from a single piece of molded foam and may be designed to buffer, reduce, and/or distribute a force generated by the pair of adjustable strap members 112, 114 and applied onto the user's knees. However, the present general inventive concept is not limited thereto.

In alternative example embodiments, the pair of force distributing knee pads 122, 124 may be formed in various shapes and sizes, including a wedge shape, to distribute or partially distribute a force from the adjustable strap members 112, 114 over a surface of the user's knees.

In the present embodiment, the first and second force distributing knee pads 122, 124 each include a strap attachment member 126 which is disposed at an angle A with respect to the knee contact region 122a, 124a.

Referring to FIG. 3B, the first and second loops 112c, 114c of the first and second adjustable strap members 112, 114 are configured to be slidably coupled within the strap attachment member 126 of the knee pads 120.

Referring to FIG. 4, the strap attachment member 126 (e.g., a slot) defines an angle B between an axis of the first and second adjustable strap members 112, 114 and the knee contact region 122a, 124a of the knee pads 120 and an angle C between the first and second adjustable strap members 112, 114 and the back support member 102. In alternative embodiments, angles B and C may define an amount of the support force FS generated by the back support device 100 that is distributed along horizontal and vertical planes P1 and P2, respectively. In the present example embodiment, the angles A, B, and C may range between about 5 degrees to about 45 degrees. However, the present general inventive concept is not limited thereto.

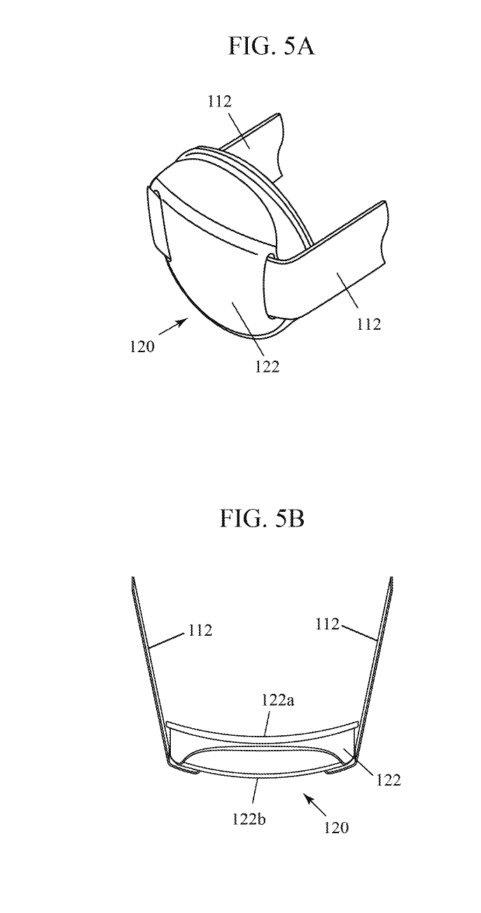

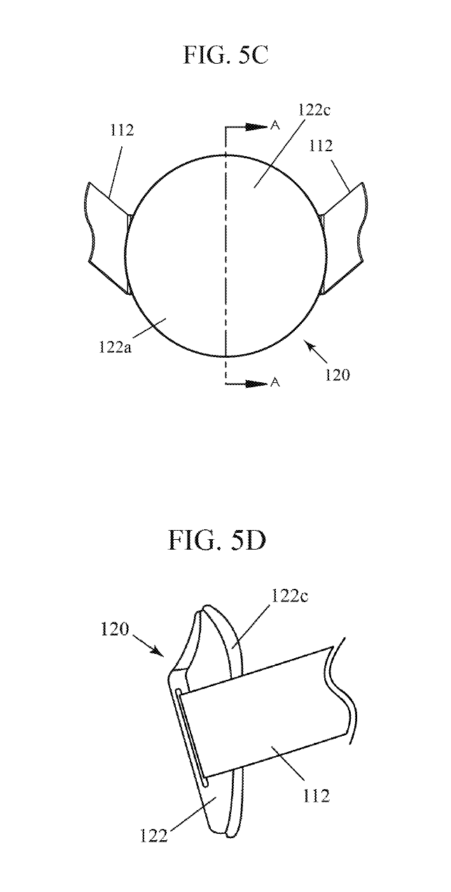

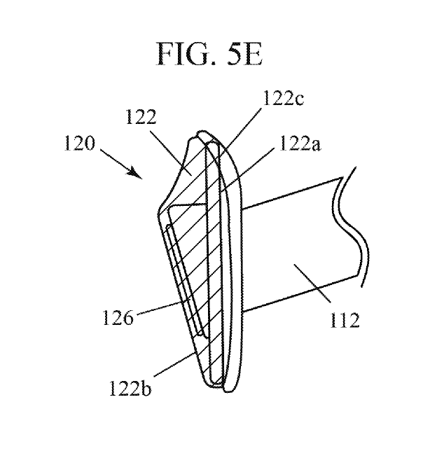

FIG. 5A illustrates a side perspective view of the force distributing knee pad 122 illustrated in FIG. 1, FIG. 5B illustrates a top plan view of the force distributing knee pad 122 illustrated in FIG. 5A, and FIG. 5C illustrates a back view of the force distributing knee pad 122 illustrated in FIG. 5B. FIG. 5D illustrates a side view of the force distributing knee pad 122 illustrated in FIG. 5A and FIG. 5E illustrates a partial cross-sectional view of the force distributing knee pad 122 along line A-A illustrated in FIG. 5C.

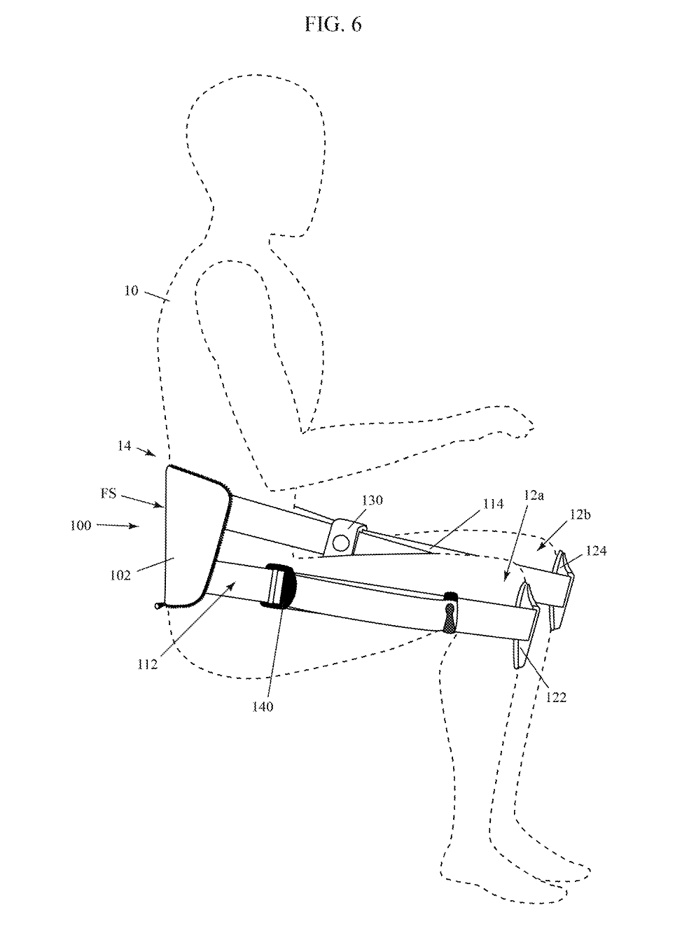

FIG. 6 illustrates a side perspective view of a back support device 100 attached to a user's 10 knees 12 and back 14.

Referring to FIG. 6, in the present embodiment, the back support device (or apparatus) 100 is used to apply a support force FS onto a user's back 14 through the back support member 102. The support force FS is generated by wrapping the first and second adjustable strap members 112, 114 and the force distributing knee pads 120 around the user's knees, when he or she is in a seated position. More specifically, the first adjustable strap member 112 and the first force distributing knee pad 122 are placed around the user's first knee 12a, and the second adjustable strap member 114 and the second force distributing knee pad 124 are placed around the user's second knee 12b while the back support member 102 is placed against the users back 14 (or lumbar region) to create the support force FS used to support and/or maintain the user 10 in a proper sitting posture.

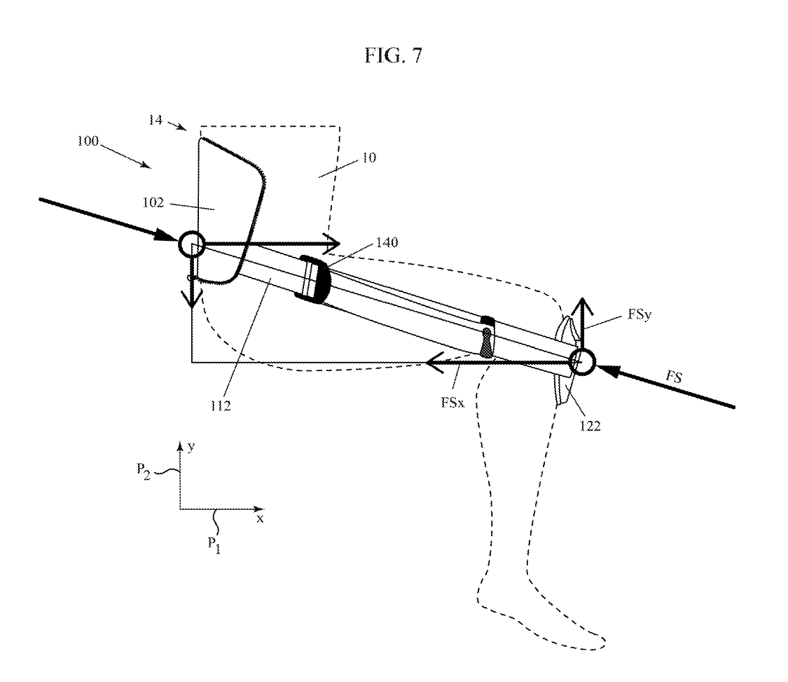

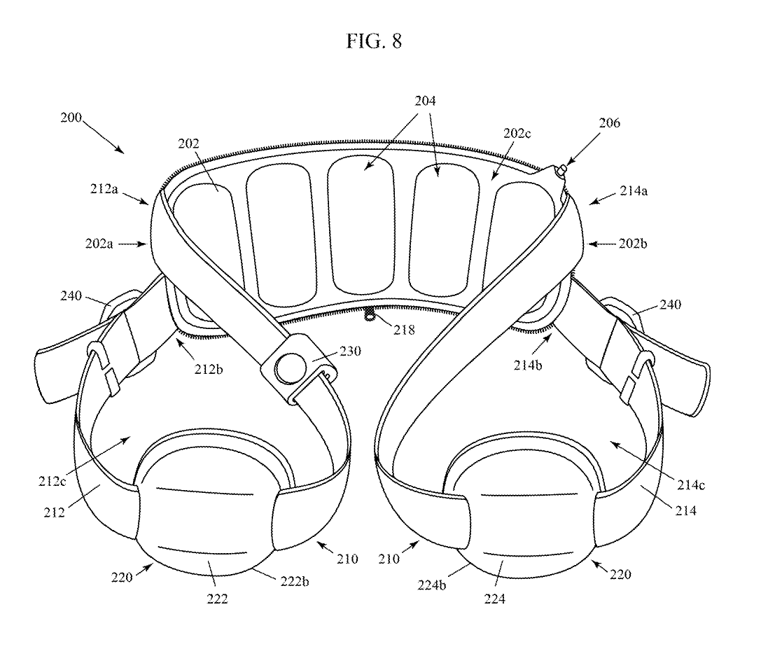

FIG. 7 illustrates a side view of the back support device 100 and force distributing knee pads 120 illustrated in FIG. 1 attached to a user's back and knees.

Referring to FIGS. 4 and 7, in the present embodiment, a magnitude of the support force FS applied by the back support member 102 onto the user's 10 back 14 may be adjusted (i.e., increased or decreased) by adjusting a longitudinal length L1 of the first and second adjustable strap members 112 and 114. That is, the first and second adjustable strap members 112, 114 further include buckles, strap coupling devices, and/or various other adjusting means 140 which are designed and/or configured to allow the user to change a length (i.e., a longitudinal length L1) of one or both of the first and second loops 112c, 114c, thereby adjusting an amount of tension and/or force applied by the back support member 102 and first and second strap members 112, 114 on the user's back 14 and knees 12, respectively. Further, a magnitude or amount of the support force FS which is distributed along the horizontal and vertical planes P1, P2 of the user's knee 12 is based on the angle A between the strap attachment member 126 and the knee contact region 122a. In the present embodiment, the magnitude of the support force FS that is distributed along the horizontal plane P1 (i.e., horizontal axis X) is determined by the following equation:

FSx=FS*cos(θ)

Similarly, the magnitude of the support force FS that is distributed along the vertical plane P2 is determined by the following equation:

FSy=FS*sin(θ)

For instance, in an exemplary embodiment in which the angle A between the strap attachment member 126 and the knee contact region 122a is 15 degrees and the support force FS applied to the user's back is equal to 20 newtons (N), the amount of force distributed along the horizontal x-axis FSx is calculated as follows:

FSx=FS*cos(θ)

FSx=20 N*cos(15)

FSx=20 N*cos(15)

FSx=20 N*0.965

FSx=19.32 N

Similarly, the amount of force distributed along the vertical y-axis FSy is calculated as follows:

FSy=FS*sin(θ)

FSy=20 N*sin(15)

FSy=20 N*sin(15)

FSy=20 N*0.258

FSy=5.17 N

As such, in the present embodiment, a support force FS equal to 20 N that is applied to a users knees through the first and second strap members 112, 114 is distributed to 19.32 N along the horizontal x-axis (i.e, horizontal plane P1) and 5.17 N along the vertical y-axis (i.e., vertical plane P2) due to the force distributing knee pad 122. As a result, the user experiences a reduced amount of stress on their knees which allows them so sit in the proper posture for an extended period of time.

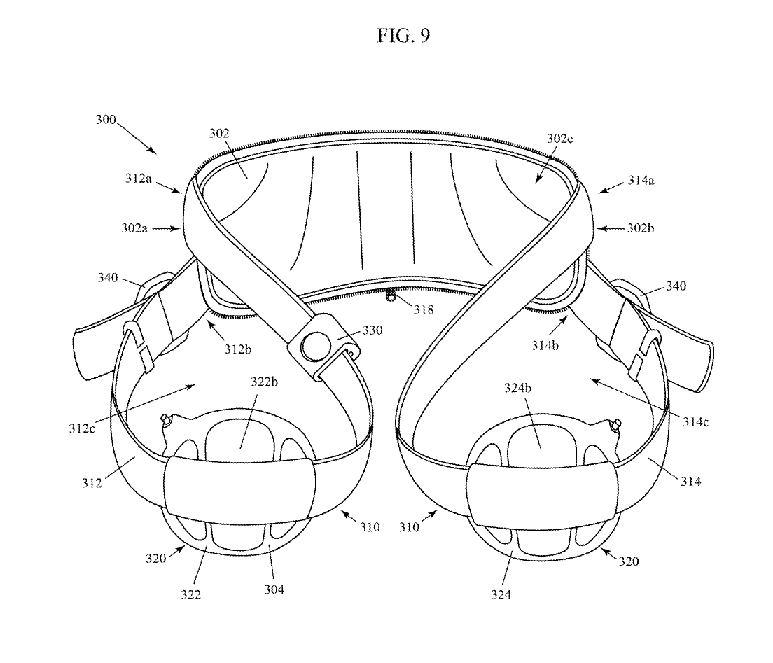

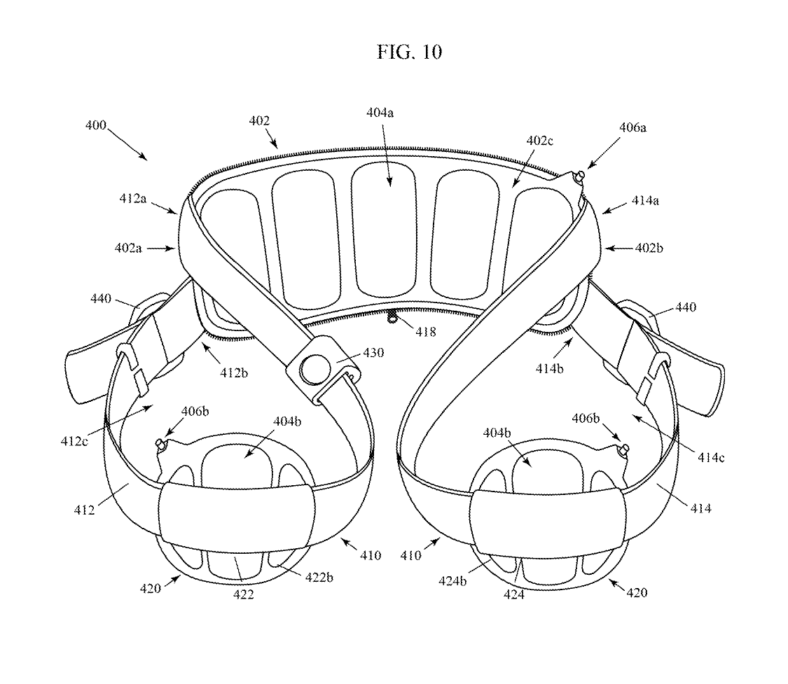

FIG. 8 illustrates a front perspective view of a back support device 200 and force distributing knee pads 220 according to another example embodiment of the present general inventive concept. FIG. 9 illustrates a front perspective view of a back support device 300 and force distributing knee pads 320 according to another example embodiment of the present general inventive concept. FIG. 10 illustrates a front perspective view of a back support device 400 and force distributing knee pads 420 according to another example embodiment of the present general inventive concept.

The following example embodiments are substantially similar to the embodiments described above and therefore overlapping elements have been omitted for convenience. However, components, elements, and features described in specific embodiments may be interchanged or added to other embodiments disclosed herein.

Referring now to FIG. 8, the back support device 200 includes a back support member 202 having a first end 202a (i.e., a proximal end), an opposing second end 202b (i.e., a distal end), a first surface 202c (i.e., a front surface), and an opposing second surface (i.e., a back surface). The back support device 200 further includes a pair of adjustable strap members 210 attached to the first and second ends 202a and 202b of the back support member 202, and a pair of force distributing knee pads 220 slidably coupled to the adjustable strap members 210. The pair of adjustable strap members 210 includes a first adjustable strap member 212 coupled to first end 202a of the back support member 202 and a second adjustable strap member 214 coupled to the second end 202b of the back support member 202.

In the present embodiment, the pair of force distributing knee pads 220 includes a first force distributing knee pad 222 slidably coupled to the first loop 212c formed by the first adjustable strap member 212, and a second force distributing knee pad 224 slidably coupled to the second loop 214c formed by the second adjustable strap member 214. The first and second force distributing knee pads 222, 224 are designed and/or configured to receive the user's knees and to distribute a force from the pair of adjustable strap members 212, 214 along both horizontal and vertical planes P1, P2 of the user's knees.

In the present embodiment, the back support member 202 further includes an inflatable back portion 204 (e.g., air bladder) with an air valve 206 integrally formed within the back support member 202. A user may insert air or other types of gases into the inflatable back portion 204 through the air valve 206 in order to control an amount of support force that is applied by the back support member 202 onto the user's back 14. That is, the amount of support force applied by the back support member 202 onto the user's back 14 may be adjusted and/or controlled based on an amount of air disposed within the inflatable back portion 204.

Similar to previous embodiments, the amount of support force applied by the back support member 202 onto the user's back 14 may also be adjusted and/or controlled by adjusting a length L1 of the first and second adjustable strap members 212, 214.

Referring now to FIG. 9, the back support device 300 includes a back support member 302 having a first end 302a (i.e., a proximal end), an opposing second end 302b (i.e., a distal end), a first surface 302c (i.e., a front surface), and an opposing second surface (i.e., a back surface). The back support device 300 further includes a pair of adjustable strap members 310 attached to the first and second ends 302a and 302b of the back support member 302, and a pair of force distributing knee pads 320 slidably coupled to the adjustable strap members 310. The pair of adjustable strap members 310 includes a first adjustable strap member 312 coupled to first end 302a of the back support member 302 and a second adjustable strap member 314 coupled to the second end 302b of the back support member 302.

In the present embodiment, the pair of force distributing knee pads 320 includes a first force distributing knee pad 322 slidably coupled to the first loop 312c formed by the first adjustable strap member 312, and a second force distributing knee pad 324 slidably coupled to the second loop 314c formed by the second adjustable strap member 314. The first and second force distributing knee pads 322, 324 are designed and/or configured to receive the user's knees and to distribute a force from the pair of adjustable strap members 312, 314 along both horizontal and vertical planes P1, P2 of the user's knees.

In the present embodiment, the back support member 302 further includes an inflatable knee portion 304 (e.g., air bladder) with an air valve 306 integrally formed within the pair of force distributing knee pads 320.

A user may insert air or other types of gases into the inflatable knee portion 304 through the air valve 306 in order to control an amount of support force that is applied by the back support member 302 onto the user's back 14. That is, the amount of support force applied by the back support member 302 onto the user's back 14 may be adjusted and/or controlled based on an amount of air disposed within the inflatable knee portion 304.

Similar to previous embodiments, the amount of support force applied by the back support member 302 onto the user's back 14 may also be adjusted and/or controlled by adjusting a length L1 of the first and second adjustable strap members 312, 314.

Referring now to FIG. 10, the back support device 400 includes a back support member 402 having a first end 402a (i.e., a proximal end), an opposing second end 402b (i.e., a distal end), a first surface 402c (i.e., a front surface), and an opposing second surface (i.e., a back surface). The back support device 400 further includes a pair of adjustable strap members 410 attached to the first and second ends 402a and 402b of the back support member 402, and a pair of force distributing knee pads 420 slidably coupled to the adjustable strap members 410. The pair of adjustable strap members 410 includes a first adjustable strap member 412 coupled to first end 402a of the back support member 402 and a second adjustable strap member 414 coupled to the second end 402b of the back support member 402.

In the present embodiment, the pair of force distributing knee pads 420 includes a first force distributing knee pad 422 slidably coupled to the first loop 412c formed by the first adjustable strap member 412, and a second force distributing knee pad 424 slidably coupled to the second loop 414c formed by the second adjustable strap member 414. The first and second force distributing knee pads 422, 424 are designed and/or configured to receive the user's knees and to distribute a force from the pair of adjustable strap members 412, 414 along both horizontal and vertical planes P1, P2 of the user's knees.

In the present embodiment, the back support member 402 further includes an inflatable back portion 404a (e.g., air bladder) with an air valve 406a integrally formed within the back support member 402 and an inflatable knee portion 404b (e.g., air bladder) with an air valve 406b integrally formed within the pair of force distributing knee pads 420. A user may insert air or other types of gases into the inflatable back portion 404a (e.g., air bladder) through the air valve 406a and/or into the inflatable knee portion 404b through the air valve 406b in order to control an amount of support force that is applied by the back support member 402 onto the user's back 14.

That is, the amount of support force applied by the back support member 402 onto the user's back 14 may be adjusted and/or controlled based on an amount of air disposed within one or more of the inflatable back portion 404a and the inflatable knee portion 404b.

Similar to previous embodiments, the amount of support force applied by the back support member 402 onto the user's back 14 may also be adjusted and/or controlled by adjusting a length L1 of the first and second adjustable strap members 412, 414.

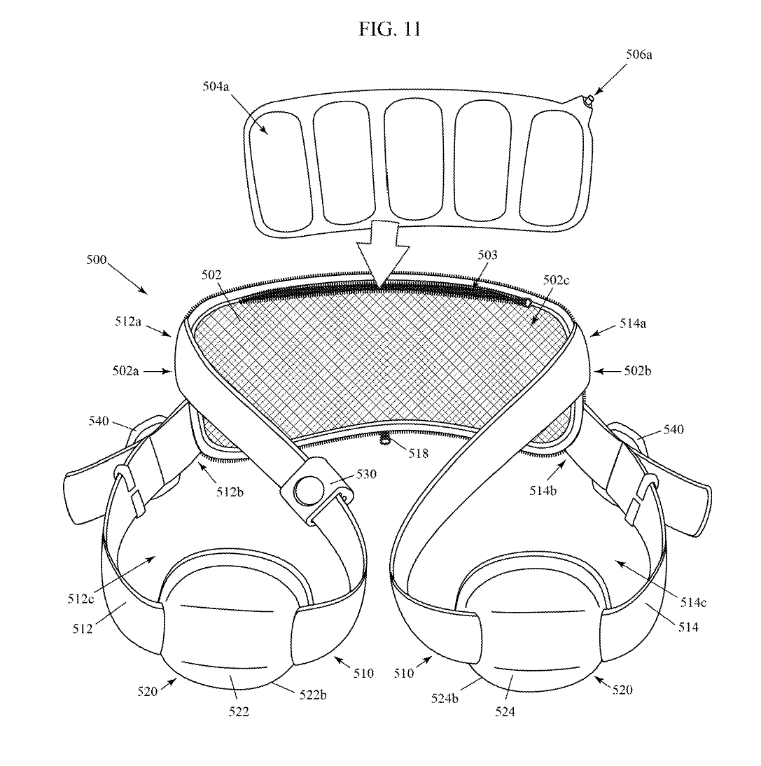

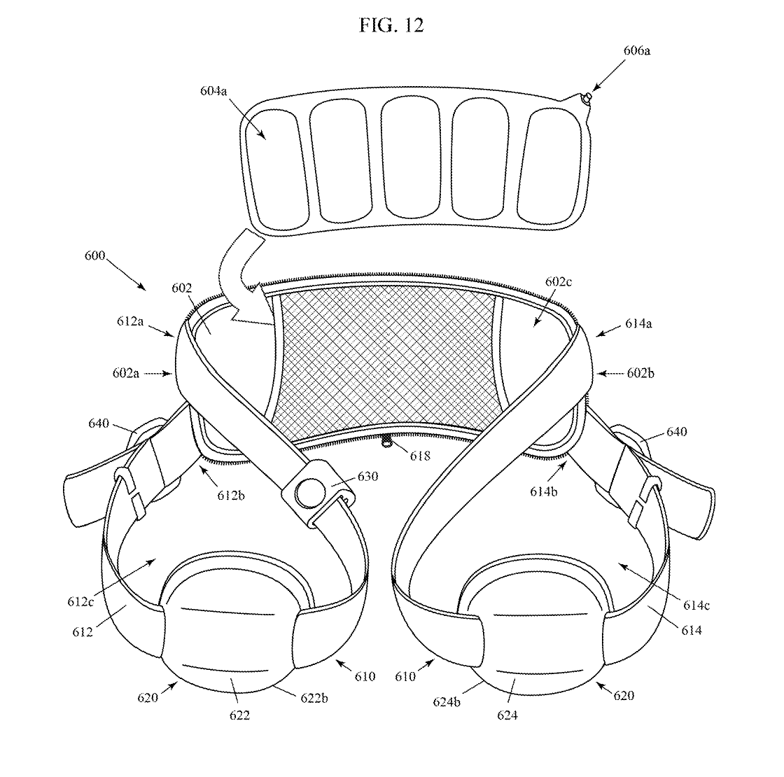

FIG. 11 illustrates a front perspective view of a back support device 500 and force distributing knee pads 520 according to another example embodiment of the present general inventive concept. FIG. 12 illustrates a front perspective view of a back support device 600 and force distributing knee pads 620 according to another example embodiment of the present general inventive concept.

Referring to FIGS. 11-12, the back support devices 500 and 600 are substantially similar to the embodiment illustrated in FIG. 8, but in these example embodiments the inflatable back portions are detachably coupled to the back support member.

Referring now to FIG. 11, the back support device 500 includes a back support member 502 having a first end 502a (i.e., a proximal end), an opposing second end 502b (i.e., a distal end), a first surface 502c (i.e., a front surface), and an opposing second surface (i.e., a back surface). The back support device 500 further includes a pair of adjustable strap members 510 attached to the first and second ends 502a and 502b of the back support member 502, and a pair of force distributing knee pads 520 slidably coupled to the adjustable strap members 510. The pair of adjustable strap members 510 includes a first adjustable strap member 512 coupled to first end 502a of the back support member 502 and a second adjustable strap member 514 coupled to the second end 502b of the back support member 502.

In the present embodiment, the pair of force distributing knee pads 520 includes a first force distributing knee pad 522 slidably coupled to the first loop 512c formed by the first adjustable strap member 512, and a second force distributing knee pad 524 slidably coupled to the second loop 514c formed by the second adjustable strap member 514. The first and second force distributing knee pads 522, 524 are designed and/or configured to receive the user's knees and to distribute a force from the pair of adjustable strap members 512, 514 along both horizontal and vertical planes P1, P2 of the user's knees.

In the present embodiment, the back support member 502 further includes a storage compartment 503 integrally formed within the back support member 502 in which an inflatable back portion 504a (e.g., air bladder) having an air valve 506a may be stored. In alternative example embodiments, the storage compartment 503 may be formed as a sleeve 603 on the back support member 502, 602 (see FIG. 12).

A user may insert air or other types of gases into the inflatable back portion 504a (e.g., air bladder) through the air valve 506a and then place the inflatable back portion 504a within the storage compartment 503 in order to control an amount of support force that is applied by the back support member 502 onto the user's back 14. That is, the amount of support force applied by the back support member 502 onto the user's back 14 may be adjusted and/or controlled based on an amount of air disposed within the detachable back portion 504a.

The present general inventive concept provides a back support device within integrated force distributing knee pads that help maintain the user in a healthy sitting posture while reducing an amount of stress applied to the user's knees, to reduce user fatigue.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

What is claimed is:

1. A back support apparatus for applying a support force to a user's back by using the user's knees while in a seated position, the apparatus comprising:
a back support member having a first end and an opposing second end;
a pair of adjustable strap members coupled to and extending from the first and second ends of the back support member; and
a pair of force distributing knee pads slidably coupled to the pair of adjustable strap members, the force distributing knee pads configured to receive the user's knees and to distribute a force applied by the pair of adjustable strap members along both horizontal and vertical planes,
wherein a first adjustable strap member and a first force distributing knee pad is placed around the user's first knee, and a second adjustable strap member and a second force distributing knee pad is placed around the user's second knee, and
wherein the support force applied by the back support member onto the user's back is generated by adjusting a length of the first and second adjustable strap members.

2. The back support apparatus of claim 1, wherein the first adjustable strap member includes a first end and an opposing second end coupled to the first end of the back support member, and the second adjustable strap member includes a first end and an opposing second end coupled to the second end of the back support member.

3. The back support apparatus of claim 2, wherein the pair of force distributing knee pads further includes a knee contact region to contact the user's knee.

4. The back support apparatus of claim 3, wherein the pair of force distributing knee pads are formed in a wedge shape to evenly distribute a force over a surface of the user's knees.

5. The back support apparatus of claim 4, wherein the knee contact region includes a padding material to protect the user's knee.

6. The back support apparatus of claim 2, wherein the pair of force distributing knee pads each include a strap attachment member positioned at an angle with respect to the knee contact region.

7. The back support apparatus of claim 6, wherein the angle is between 5 degrees to 45 degrees.

8. The back support apparatus of claim 7, wherein the support force applied to the user's back at the back support member is generated by the user's first and second knees through the first and second adjustable strap members to thereby support the user in a proper posture position.

9. The back support apparatus of claim 8, wherein an amount of the support force distributed along the horizontal plane is based on the angle between the strap attachment member and the knee contact region.

10. The back support apparatus of claim 8, wherein an amount of the support force distributed along the vertical plane is based on the angle between the strap attachment member and the knee contact region.

11. The back support apparatus of claim 2, further comprising a fastening member coupled to a perimeter of the back support member to open and close a storage compartment formed by the back support member.

12. The back support apparatus of claim 11, wherein the fastening member includes one of a snap, a button, a zipper, a hook and loop fastener and a clip.

13. The back support apparatus of claim 2, further comprising a clip member configured to detachably connect the first adjustable strap member to the second adjustable strap member to prevent the user's knees from spreading apart.

14. A back support apparatus for applying an adjustable support force onto a user's back by using the user's knees while in a seated position, the apparatus comprising:
a back support member having a first end and an opposing second end and an inflatable back portion;
a pair of adjustable strap members coupled to and extending from the first and second ends of the back support member; and
a pair of force distributing knee pads slidably coupled to the pair of adjustable strap members, the force distributing knee pads having an inflatable knee portion configured to receive the user's knees and to adjustably distribute a force applied by the pair of adjustable strap members along both horizontal and vertical planes,
wherein a first adjustable strap member and a first force distributing knee pad is placed around the user's first knee, and a second adjustable strap member and a second force distributing knee pad is placed around the user's second knee.

15. The back support apparatus of claim 14, wherein an amount of support force applied by the back support member onto the user's back is controlled by adjusting a length of the first and second adjustable strap members.

16. The back support apparatus of claim 14, wherein an amount of support force applied by the back support member onto the user's back is controlled based on an amount of air disposed within the inflatable back portion and the inflatable knee portion.

17. The back support apparatus of claim 14, wherein the inflatable back portion and knee portion each include an air valve used to adjust an amount of air disposed with the inflatable portion.

18. The back support apparatus of claim 14, wherein the inflatable back portion is detachably coupled to the back support member.

19. The back support apparatus of claim 14, wherein the inflatable back portion is integrally formed with the back support member.
